(19) United States
(12) Patent Application Publication
(10) Pub. No.: US 2026/0322041 A1
(43) Pub. Date: Oct. 15, 2026

(54) CABLE-END CONNECTOR, BOARD-END CONNECTOR AND ELECTRICAL CONNECTION DEVICE

(71) Applicant: Molex, LLC, Lisle, IL (US)

(72) Inventors: Eugene Lim Chen Yew, Singapore (SG); Eng Kan Soh, Singapore (SG); Yueh-Ting Chiang, Taoyuan County (TW); Jun Yang, Lisle, IL (US)

(21) Appl. No.: 19/711,988

(22) Filed: Jun. 18, 2026

Related U.S. Application Data
(63) Continuation of application No. 19/635,853, filed on Apr. 1, 2026.

(30) Foreign Application Priority Data
Apr. 2, 2025 (CN) 202510419423.5

(51) Int. Cl. H01R 13/6585; H01R 12/75; H01R 13/6471

(52) U.S. Cl. CPC H01R 13/6585; H01R 12/75; H01R 13/6471

(57) ABSTRACT

An electrical connection device includes a board-end connector and a cable-end connector which is capable of being mated with the board-end connector. The board-end connector includes two terminal modules. The terminal module includes a plurality of plate-shaped signal terminals and a plurality of plate-shaped ground terminals. The plate-shaped ground terminal has a second plate-shaped connecting portion, a second plate-body portion, a plate-shaped elastic contact end, two plate-shaped shielding portions which are respectively connected at two sides of the second plate-shaped connecting portion, and two plate-shaped tail portions which respectively extend downwardly from the two plate-shaped shielding portions. A width of the second plate-shaped connecting portion in a left-right direction is less than a width of the second plate-body portion in the left-right direction, a length that the plate-shaped tail portion extends is larger than or equal to a length of a tail end of the plate-shaped signal terminal which extend. By the design as described above, the electrical connection device in which mechanical requirement and electrical requirement are not affected in reduced space can be provided.

### TECHNICAL FIELD

The present disclosure relates to an electrical connection device, and particularly relates to an electrical connection device and a cable-end connector and a board-end connector thereof which are adapted to high data rate application.

### BACKGROUND

An existing electrical connection device includes a board-end connector and a cable-end connector which is separably mated with the board-end connector. The board-end connector includes a plurality of terminals which are arranged side by side together. The cable-end connector includes a plurality of terminals which are arranged side by side together.

In order to satisfy new generation server system requirements, the electrical connection device must satisfy high data rate transmission and an entire volume need be designed to be smaller. However, when a distance between the terminals is reduced, the terminals will become too dense, a problem that crosstalk will be increased arises, and the terminal structure also must provide sufficient robust to support mechanical performance of an assembling process under requirement of reduced volume. Therefore, how to research and develop an electrical connection device which satisfies mechanical requirement and electrical requirement in a situation that a physical space is reduced indeed is one of objects for industry efforts.

### SUMMARY

Therefore, an object of the present disclosure is to provide a cable-end connector which is can improve at least one deficiency in prior art.

Accordingly, a cable-end connector of the present disclosure comprises an insulative housing, a first terminal wafer, a second terminal wafer, a second terminal wafer and a plurality of second cables. The first terminal wafer is provided to the insulative housing, and comprises a plurality of first signal terminal pairs, a plurality of first ground terminals, a first ground shield, a second ground shield, and a first cladding assembly. Two sides of the first signal terminal pair each are provided with the first ground terminal, and the first signal terminal pair has two first signal terminals. The first signal terminal has a first body portion and a first tail portion and a first contact portion which respectively extend outwardly from two ends of the first body portion. The first ground terminal has a second body portion and a second tail portion and a second contact portion which respectively extend outwardly from two ends of the second body portion. The first ground shield is electrically connected to the second body portions, the second ground shield is electrically connected to the second tail portions. The second terminal wafer is provided to the insulative housing, and comprises a plurality of second signal terminal pairs, a plurality of second ground terminals, a third ground shield, a fourth ground shield, and a second cladding assembly. Two sides of the second signal terminal pair each are provided with the second ground terminal, and the second signal terminal pair has two second signal terminals. The second signal terminal has a third body portion and a third tail portion and a third contact portion which respectively extend outwardly from two ends of the third body portion. The second ground terminal has a fourth body portion and a fourth tail portion and a fourth contact portion which respectively extend outwardly from two ends of the fourth body portion. The third ground shield is electrically connected to the fourth body portions, the fourth ground shield is electrically connected to the fourth tail portions. The plurality of first cables are electrically connected to the first tail portions and the second tail portions. The plurality of second cables are electrically connected to the third tail portions and the fourth tail portions.

Another object of the present disclosure is to provide a board-end connector which can improve at least one deficiency in prior art.

Accordingly, a board-end connector of the present disclosure comprises a metal shell, an insulative body and two terminal modules. The insulative body is provided in the metal shell. The two terminal modules are received in the insulative body. The terminal module comprises an insulative base which is provided to the insulative body, a terminal array, a plate-shaped ground shield, and a wave-shaped ground shield. The terminal array has a plurality of plate-shaped signal terminal pairs and a plurality of plate-shaped ground terminals. Two sides of the plate-shaped signal terminal pair each are provided with the plate-shaped ground terminal, and the plate-shaped signal terminal pair has two plate-shaped signal terminals which are spaced apart from each other. The plate-shaped signal terminal has a first plate-shaped connecting portion which is at least partially cladded by the insulative base, a first plate-body portion and a tail end which respectively extend outwardly from two ends of the first plate-shaped connecting portion, and an elastic contact end which extends outwardly from the first plate-body portion. A width of the first plate-body portion is larger than a width of the elastic contact end. The two first plate-body portions of the plate-shaped signal terminal pair are therebetween spaced apart from each other by a preset distance. The plate-shaped ground terminal has a second plate-shaped connecting portion which is at least partially cladded by the insulative base, a second plate-body portion which extends outwardly from the second plate-shaped connecting portion, a plate-shaped elastic contact end which extends outwardly from the second plate-body portion, two plate-shaped shielding portions which respectively extend from two sides of the second plate-shaped connecting portion along an extending direction of the tail end, and two plate-shaped tail portions which respectively downwardly extend from tips of the two plate-shaped shielding portions. A width of the second plate-body portion is larger than a width of the plate-shaped elastic contact end and is larger than the width of the first plate-body portion. A length of the plate-shaped tail portion which extends in the same direction as the extending direction of the tail end is larger than or equal to the tail end, the plate-shaped ground shield and the wave-shaped ground shield are cladded by the insulative base and are electrically connected to the plate-shaped ground terminals, and are respectively positioned at two opposite sides of the plate-shaped ground terminals.

Still another object of the present disclosure is to provide an electrical connection device which can improve at least one deficiency in prior art.

Accordingly, an electrical connection device of the present disclosure comprises the cable-end connector as described as above and the board-end connector as described as above. The two terminal modules electrically connect the first terminal wafer and the second terminal wafer of the cable-end connector respectively.

A technical effect of the present disclosure lies in that: by that the electrical connection device comprises the cable-end connector as described above and the board-end connector as described above, the electrical connection device, in which mechanical requirement and electrical requirement are not affected in a situation that a physical space is reduced, is provided.

Another object of the present disclosure is to provide a board-end connector which can improve at least one deficiency in prior art.

Accordingly, a board-end connector of the present disclosure comprises a metal shell, an insulative body and two terminal modules. The insulative body is provided in the metal shell. The two terminal modules are received in the insulative body, the terminal module comprises an insulative base which is provided to the insulative body, a terminal array, a plate-shaped ground shield, and a wave-shaped ground shield. The terminal array has a plurality of plate-shaped signal terminal pairs and a plurality of plate-shaped ground terminals. Two sides of the plate-shaped signal terminal pair each are provided with the plate-shaped ground terminal, and the plate-shaped signal terminal pair has two plate-shaped signal terminals which are spaced apart from each other. The plate-shaped signal terminal has a first plate-shaped connecting portion which is at least partially cladded by the insulative base, a first plate-body portion and a tail end which respectively extend outwardly from two ends of the first plate-shaped connecting portion, and an elastic contact end which extends outwardly from the first plate-body portion. The first plate-body portion has a first face which faces the other first plate-body portion, and a second face which is opposite to the first face. The first face has a first oblique face portion which extends obliquely from the elastic contact end toward the down and toward the other first plate-body portion, and a first vertical face portion which connects the first oblique face portion and the first plate-shaped connecting portion. The first vertical face portion is parallel to the first vertical face portion of the other first plate-body portion, the second face has a second oblique face portion which extends obliquely from the first plate-shaped connecting portion toward the up and toward the other first plate-body portion. The first plate-shaped connecting portion has a third face which faces the other first plate-shaped connecting portion and has a third vertical face portion, the third vertical face portion is parallel to the third vertical face portion of the other first plate-shaped connecting portion. The plate-shaped ground terminal has a second plate-shaped connecting portion which is at least partially cladded by the insulative base, a second plate-body portion which extends outwardly from the second plate-shaped connecting portion, a plate-shaped elastic contact end which extends outwardly from the second plate-body portion, two plate-shaped shielding portions which respectively extend from two sides of the second plate-shaped connecting portion along an extending direction of the tail end, and two plate-shaped tail portions which respectively downwardly extend from tips of the two plate-shaped shielding portions. A width of the second plate-body portion is larger than a width of the plate-shaped elastic contact end and is larger than a width of the first plate-body portion. The second plate-body portion has an opening and comprises two side segments which define two sides of the opening. A width of the side segment gradually increases from up to down. A length of the plate-shaped tail portion which extends in the same direction as the extending direction of the tail end is larger than or equal to the tail end. A distance between the second plate-shaped connecting portion of the plate-shaped ground terminal and the first plate-shaped connecting portion of the adjacent plate-shaped signal terminal is larger than a distance between the second plate-body portion of the plate-shaped ground terminal and the first plate-body portion of the adjacent plate-shaped signal terminal, the distance between the second plate-shaped connecting portion of the plate-shaped ground terminal and the first plate-shaped connecting portion of the adjacent plate-shaped signal terminal is larger than a distance between the first plate-shaped connecting portions of the plate-shaped signal terminal pair. The plate-shaped ground shield and the wave-shaped ground shield are cladded by the insulative base and are electrically connected to the plate-shaped ground terminals, and are respectively positioned to two opposite sides of the plate-shaped ground terminals.

A technical effect of the present disclosure lies in that: by the design of the plate-shaped signal terminal and the plate-shaped ground terminal, the present disclosure can provide the board-end connector in which mechanical requirement and electrical requirement are not affected in a reduced space.

### BRIEF DESCRIPTION OF THE DRAWINGS

Other features and effects of the present disclosure will be apparent from an embodiment with reference to the drawings, in which:

FIG. 1 is a perspective view illustrating an embodiment of a cable-end connector, a board-end connector and an electrical connection device of the present disclosure and illustrating that the cable-end connector and the board-end connector are mated with each other of state;

FIG. 2 is a cross-sectional view illustrating a state that the cable-end connector and the board-end connector of the embodiment are mated with each other;

FIG. 3 is a perspective exploded view illustrating that the cable-end connector and the board-end connector of the embodiment are separated from each other;

FIG. 4 is a perspective exploded view illustrating an assembling relationship of a metal shell, an insulative body and two terminal modules of the board-end connector of the embodiment;

FIG. 5 is an incomplete perspective exploded view illustrating an assembling relationship between the terminal modules of the board-end connector of the embodiment;

FIG. 6 is a perspective exploded view illustrating an assembling relationship of one of the terminal modules of the embodiment with an insulative base omitted;

FIG. 7 is an incomplete perspective view illustrating an arrangement relationship among a plurality of plate-shaped signal terminal pairs and a plurality of plate-shaped ground terminals of one of the terminal modules of the embodiment;

FIG. 8 is an incomplete front view illustrating one plate-shaped signal terminal pair and two adjacent plate-shaped ground terminals of the embodiment;

FIG. 9 is a side view illustrating one of the terminal modules of the embodiment with the insulative base omitted;

FIG. 10 is an incomplete cross-sectional view illustrating one of the terminal modules of the embodiment with the insulative base omitted;

FIG. 11 is a perspective exploded view illustrating an assembling relationship of the cable-end connector of the embodiment;

FIG. 12 is a perspective view illustrating a first terminal wafer and a second terminal wafer of the cable-end connector of the embodiment;

FIG. 13 is a perspective exploded view illustrating an assembling relationship between the first terminal wafer and the second terminal wafer of the embodiment;

FIG. 14 is a perspective exploded view illustrating an assembling relationship between the first terminal wafer and a plurality of first cables of the embodiment with a first cladding assembly omitted;

FIG. 15 is an incomplete perspective view illustrating an assembling relationship between the first terminal wafer and the plurality of first cables of the embodiment with the first cladding assembly omitted;

FIG. 16 is a perspective exploded view illustrating an assembling relationship between the second terminal wafer and a plurality of second cables of the embodiment with a second cladding assembly omitted; and

FIG. 17 is an incomplete perspective view illustrating an assembling relationship between the second terminal wafer and the plurality of second cables of the embodiment with the second cladding assembly omitted.

Reference numerals are presented as follows.
100 electrical connection device
101 board-end connector
102 cable-end connector
11 metal shell
111 first pin
12 insulative body
120 receiving space
121 second pin
2 terminal module
21 insulative base
211 base-body portion
212 protruding portion
213 snapping groove
22 terminal array
23 plate-shaped ground shield
230 first penetrating hole
24 wave-shaped ground shield
240 second penetrating hole
241 connecting portion
242 wave portion
25 plate-shaped signal terminal pair
26 plate-shaped ground terminal
261 second plate-shaped connecting portion
262 second plate-body portion
2621 transverse segment
2622 side segment
2623 opening
263 plate-shaped elastic contact end
264 plate-shaped shielding portion
265 plate-shaped tail portion
27 plate-shaped signal terminal
271 first plate-shaped connecting portion
272 first plate-body portion
273 elastic contact end
274 tail end
275 first face
2751 first oblique face portion
2752 first vertical face portion
276 second face
2761 second oblique face portion
2762 second vertical face portion
277 third face
2771 third vertical face portion
3 insulative housing
31 main body portion
32 supporting portion
33 protruding post
34 retaining groove
4 first cable
41 first signal conductor
42 first ground conductor
43 first connecting segment
44 first extending segment
5 second cable
51 second signal conductor
52 second ground conductor
53 second connecting segment
54 second extending segment
6 first terminal wafer
61 first signal terminal pair
62 first ground terminal
621 second body portion
622 second tail portion
623 second contact portion
63 first ground connecting piece
64 first ground shield
65 second ground shield
66 first cladding assembly
661 first support member
662 first cladding member
663 second cladding member
67 first signal terminal
671 first body portion
672 first tail portion
673 first contact portion
7 second terminal wafer
71 second signal terminal pair
72 second ground terminal
721 fourth body portion
722 fourth tail portion
723 fourth contact portion
73 second ground connecting piece
74 third ground shield
75 fourth ground shield
76 second cladding assembly
761 second support member
762 third cladding member
763 fourth cladding member
77 second signal terminal
771 third body portion
772 third tail portion
773 third contact portion
81 locking member
82 pulling strap
9 circuit board
D1 first direction
D2 second direction
D3 third direction
H1 height
H2 height
L1 length
L2 length
W1 width
W2 width
W3 width
W4 width
W5 width

### DETAILED DESCRIPTION

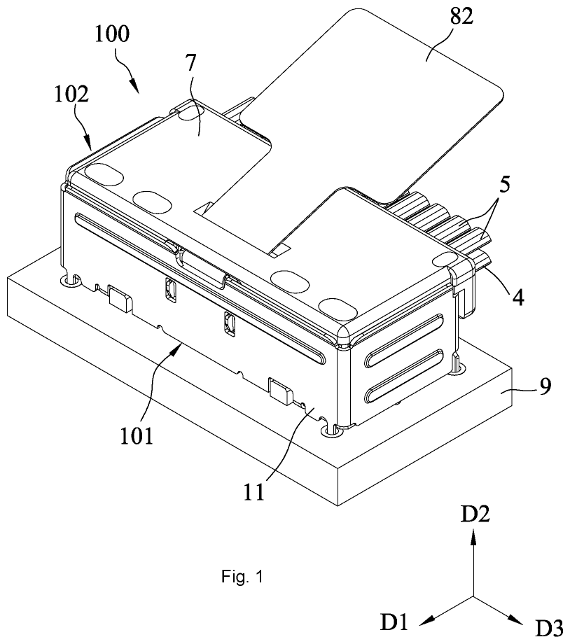

Referring to FIG. 1 to FIG. 3, an embodiment of an electrical connection device 100 of the present disclosure is adapted to be mounted on a circuit board 9, and includes a board-end connector 101 and a cable-end connector 102. The board-end connector 101 is provided on the circuit board 9 and is electrically connected with the circuit board 9. The cable-end connector 102 is separably mated with the board-end connector 101.

For convenience of later description, a first direction D1, a second direction D2 perpendicular to the first direction D1, and a third direction D3 perpendicular to the first direction D1 and the second direction D2 of the electrical connection device 100 are defined. In the present embodiment, the first direction D1 takes a front-rear direction as example, a direction to which an arrow points in FIG. 1 is front, an opposite direction is rear. The second direction D2 takes an up-down direction as example, a direction to which an arrow points in FIG. 1 is up, an opposite direction is down. The third direction D3 takes a left-right direction as example, a direction to which an arrow points in FIG. 1 is left, an opposite direction is right.

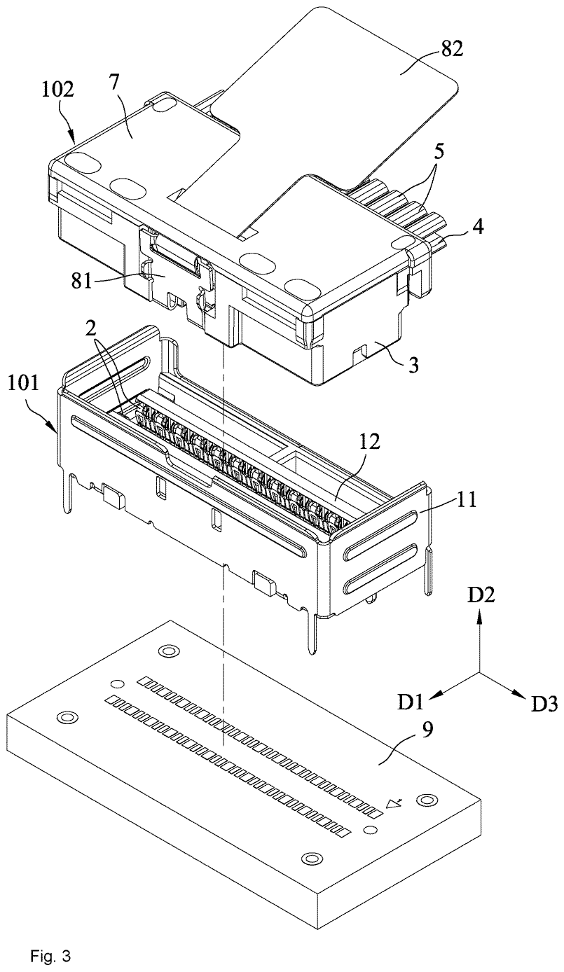

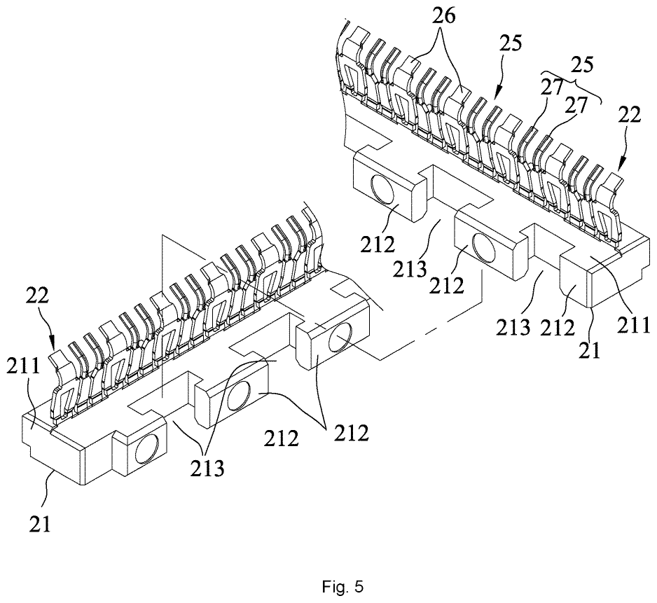

Referring to FIG. 3 to FIG. 5, the board-end connector 101includes a metal shell 11, an insulative body 12 cladded by the metal shell 11, and two terminal modules 2 provided in the insulative body 12.

The metal shell 11 is in form of oblong frame shape, and a length direction of the metal shell 11 extends along the third direction D3, and the metal shell 11 includes a plurality of first pins 111 which are respectively positioned at four corners. The metal shell 11 is provided on the circuit board 9 by that the plurality of first pins 111 are inserted into the circuit board 9.

The insulative body 12 is in form of oblong frame shape, and a length direction of the insulative body 12 extends along the third direction D3, and the insulative body 12 is provided in the metal shell 11. The insulative body 12 includes two second pins 121 which are spaced apart from each other along the third direction D3 and are inserted into the circuit board 9. The insulative body 12 has a receiving space 120 which extends along the third direction D3 and penetrates along the second direction D2.

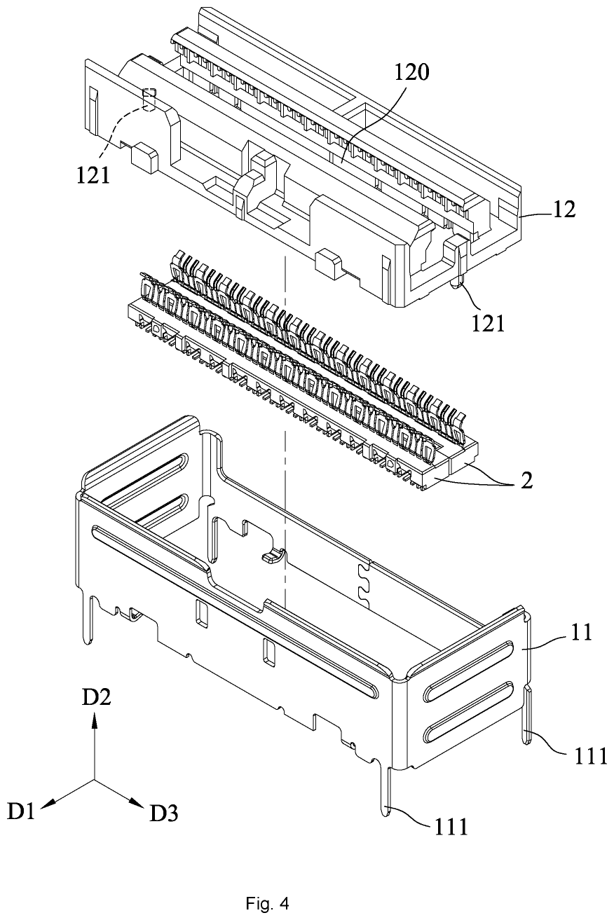

Referring to FIG. 4 to FIG. 6, the two terminal modules 2 are provide in the receiving space 120, and are engaged with and fixed in the insulative body 12. The two terminal modules 2 are reversely provided along the first direction D1. Because the two terminal modules 2 are the same in structure, hereinafter a specific structure of the terminal module 2 positioned to the front will be described.

The terminal module 2 includes an insulative base 21, a terminal array 22, a plate-shaped ground shield 23 and a wave-shaped ground shield 24. The insulative base 21 clads a part of the terminal array 22, the plate-shaped ground shield 23, and the wave-shaped ground shield 24. The insulative base 21 has a base-body portion 211 and a plurality of protruding portions 212 which are spaced apart from each other along the third direction D3 and protrude from a rear side surface of the base-body portion 211. The base-body portion 211 and the plurality of protruding portions 212 cooperate with each other to define a plurality of snapping grooves 213 which are spaced apart from each other along the third direction D3 and penetrate along the second direction D2. The plurality of protruding portions 212 of the insulative base 21 are snapped into the corresponding snapping grooves 213 of the insulative base 21 of the other terminal module 2 up and down, so that the insulative bases 21 of the two terminal modules 2 are capable of being snapped with each other. It is noted that, as long as the insulative bases 21 of the two terminal modules 2 are capable of being engaged and fixed with each other, the present disclosure is not limited to such a manner.

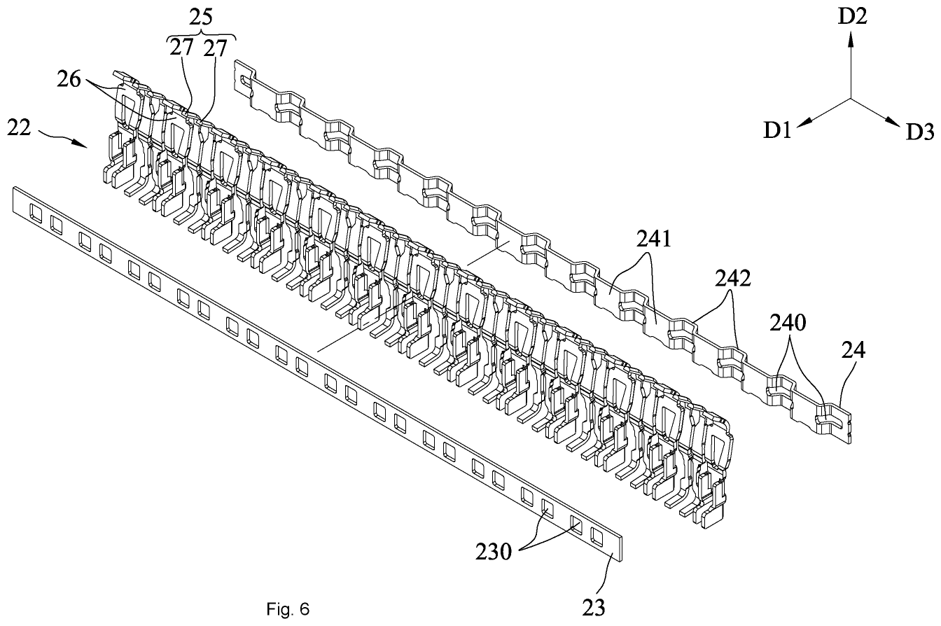

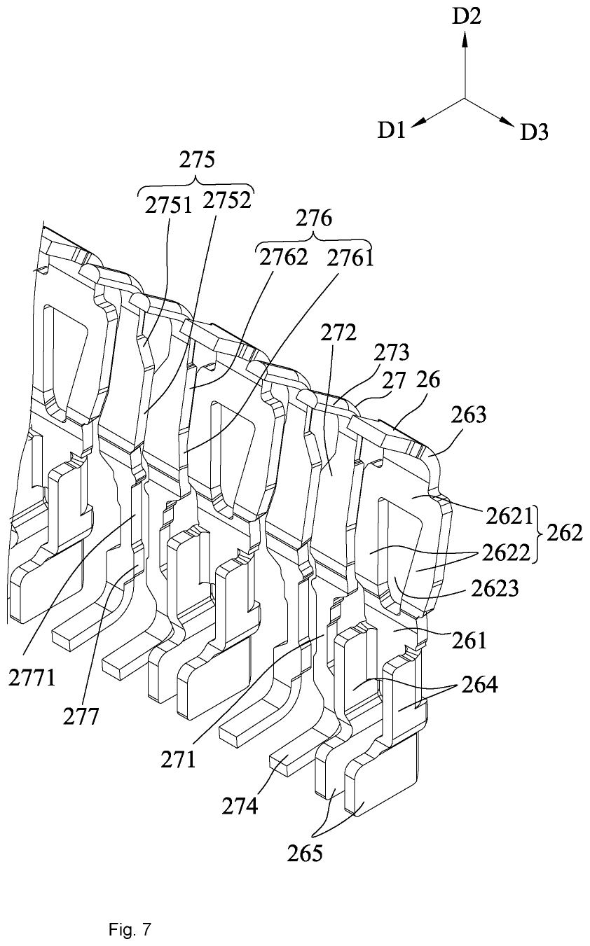

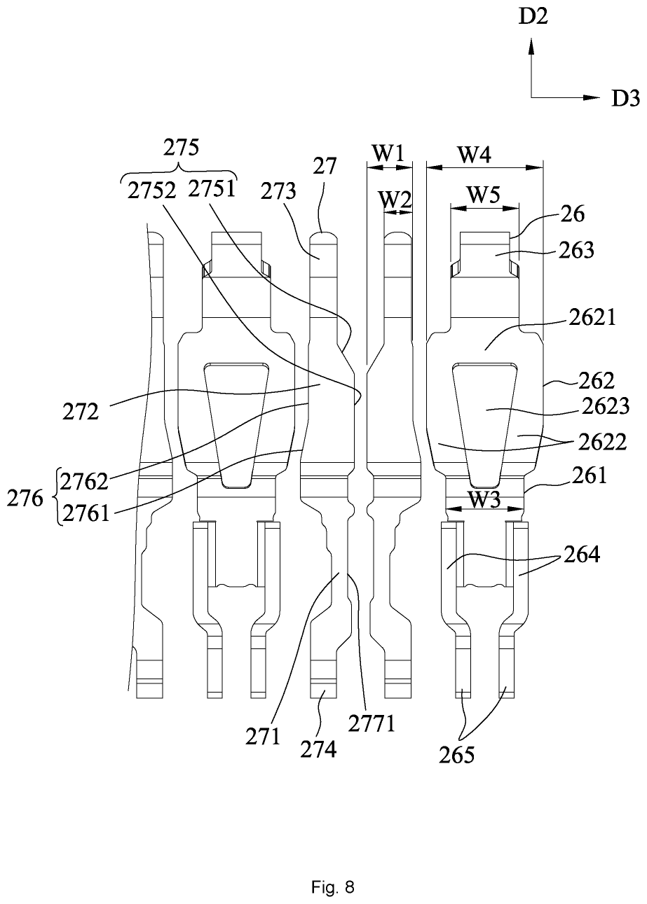

Referring to FIG. 6 to FIG. 9, the terminal array 22 has a plurality of plate-shaped signal terminal pairs 25 and a plurality of plate-shaped ground terminals 26 which are arranged and spaced apart from each other along the third direction D3. Two sides of the plate-shaped signal terminal pair 25 each are provided with the plate-shaped ground terminal 26, two sides of the plate-shaped ground terminal 26 each are provided with the plate-shaped signal terminal pair 25. Specifically, the terminal array 22 is sequentially arranged as a sequence of the plate-shaped ground terminal 26, the plate-shaped signal terminal pair 25, the plate-shaped ground terminal 26, the plate-shaped signal terminal pair 25 along the third direction D3.

The plate-shaped signal terminal pair 25 has two plate-shaped signal terminals 27 which are symmetrical left and right. The plate-shaped signal terminal 27 is in form of shape which extends up and down, and has a first plate-shaped connecting portion 271 which is partially cladded by the insulative base 21, a first plate-body portion 272 which extends upwardly from the first plate-shaped connecting portion 271 and has a width W1 along the third direction D3, an elastic contact end 273 which extends upwardly from the first plate-body portion 272 and bends forwardly as arc and has a width W2 along the third direction D3, and a tail end 274 which extends from the first plate-shaped connecting portion 271 and makes a tip thereof extend forwardly, connected and fixed on the circuit board 9 and electrically connected with the circuit board 9.

The first plate-shaped connecting portion 271 has a third face 277 which faces the other first plate-shaped connecting portion 271, the third face 277 has a third vertical face portion 2771, the third vertical face portion 2771 is parallel to the third vertical face portion 2771 of the other first plate-shaped connecting portion 271.

The width W1 of The first plate-body portion 272 is larger than the width W2 of the elastic contact end 273. The first plate-body portion 272 has a first face 275 which faces the other first plate-body portion 272, and a second face 276 which is opposite to the first face 275 (that is, faces the adjacent plate-shaped ground terminal 26). The first face 275 has a first oblique face portion 2751 which extends obliquely from the elastic contact end 273 toward the down and toward the other first plate-body portion 272, and a first vertical face portion 2752 which extends from the first oblique face portion 2751 toward the down and connects the first plate-shaped connecting portion 271. The first vertical face portion 2752 is parallel to the first vertical face portion 2752 of the other first plate-body portion 272, that is to say, the first vertical face portion 2752 and the first vertical face portion 2752 of the other first plate-body portion 272 are therebetween spaced apart from each other by a preset distance. The second face 276 has a second oblique face portion 2761 which extends obliquely from the first plate-shaped connecting portion 271 toward the up and toward the other first plate-body portion 272, and a second vertical face portion 2762 which extends from the second oblique face portion 2761 toward the up and connects the elastic contact end 273. Wherein, the design of the first oblique face portion 2751 and the second oblique face portion 2761 ensures that stress distribution is uniform during deflection of the plate-shaped signal terminal 27.

The plate-shaped ground terminal 26 is in form of shape which extends up and down, and has a second plate-shaped connecting portion 261 which is partially cladded by the insulative base 21, a second plate-body portion 262 which extends upwardly from the second plate-shaped connecting portion 261, a plate-shaped elastic contact end 263 which extends upwardly from the second plate-body portion 262 and bends forwardly as arc, two plate-shaped shielding portions 264 which respectively extend forwardly from a left side and a right side of the second plate-shaped connecting portion 261, and two plate-shaped tail portions 265 which respectively extend downwardly from bottom ends of the two plate-shaped shielding portions 264 and are partially cladded by the insulative base 21.

The second plate-shaped connecting portion 261, the second plate-body portion 262 and the plate-shaped elastic contact end 263 respectively have a width W3, a width W4 and a width W5 along the third direction D3.

The width W3 of the second plate-shaped connecting portion 261 is less than the width W4 of the second plate-body portion 262. The width W4 of the second plate-body portion 262 is larger than the width W5 of the plate-shaped elastic contact end 263, and is larger than the width W1 of the first plate-body portion 272.

The second plate-body portion 262 includes a transverse segment 2621 which extends downwardly from the plate-shaped elastic contact end 263, and two side segments 2622 which respectively extend downwardly from a left side and a right side of the transverse segment 2621 and connect the second plate-shaped connecting portion 261. A width of the side segment 2622 along the third direction D3 gradually increases from up to down. The transverse segment 2621 and the two side segment 2622 cooperate with each other to define an opening 2623 which is in form of inverted cone and penetrates along the first direction D1.

With the design manner that the width of the side segment 2622 gradually increases from up to down, when the second plate-body portion 262 is brought to move by the plate-shaped elastic contact end 263 and is subjected to a force, the two side segments 2622 are capable of dispersing a part of stress in deformation to avoid the stress concentrating at a bottom end of the second plate-body portion 262 to make the second plate-body portion 262 deformed.

In the present embodiment, the opening 2623 is in form of inverted cone, but in implementing, as along as the width of the side segment 2622 gradually increases from up to down, the opening 2623 also may be designed as a rectangle, and cooperate with that a side face of the side segment 2622 facing the plate-shaped signal terminal 27 obliquely extends toward the down and toward the plate-shaped signal terminal 27.

It is noted that, a distance between the second plate-shaped connecting portion 261 and the first plate-shaped connecting portion 271 of the adjacent plate-shaped signal terminal 27 is larger than a distance between the second plate-body portion 262 and the first plate-body portion 272 of the adjacent plate-shaped signal terminal 27, a distance between the second plate-shaped connecting portion 261 and the first plate-shaped connecting portion 271 of the adjacent plate-shaped signal terminal 27 is larger than a distance between the two first plate-shaped connecting portions 271 of the plate-shaped signal terminal pair 25.

The plate-shaped tail portion 265 is fixed on the circuit board 9 and is electrically connected with the circuit board 9, and transversely shields the tail end 274 of the adjacent plate-shaped signal terminal 27. Specifically, a length L1 of the plate-shaped tail portion 265 along the first direction D1 is larger than or equal to a length L2 of the tail end 274 along the first direction D1, and a height H1 of the plate-shaped tail portion 265 along the second direction D2 is larger than or equal to a height H2 of the tail end 274 along the second direction D2. It is noted that, the two plate-shaped tail portions 265 may be together soldered on a pad (not shown) of the circuit board 9, but also may be respectively soldered on different pads.

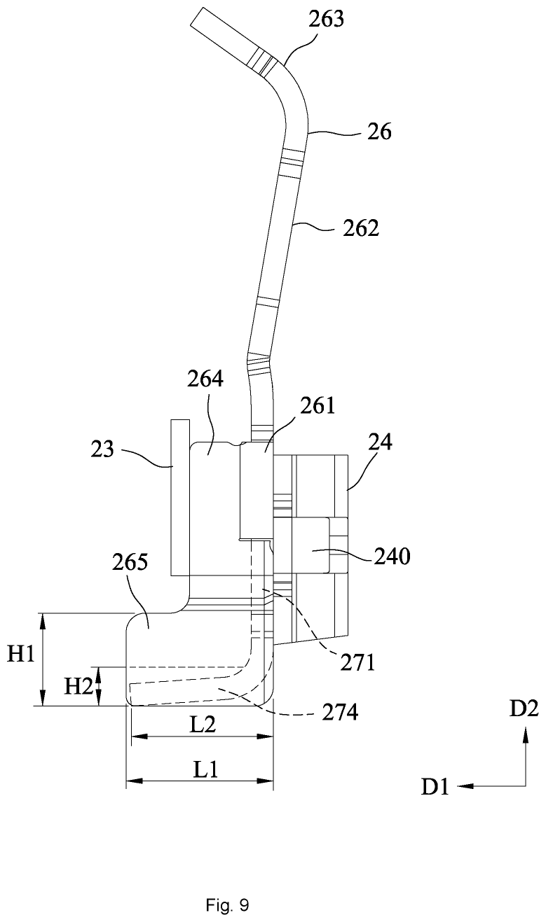

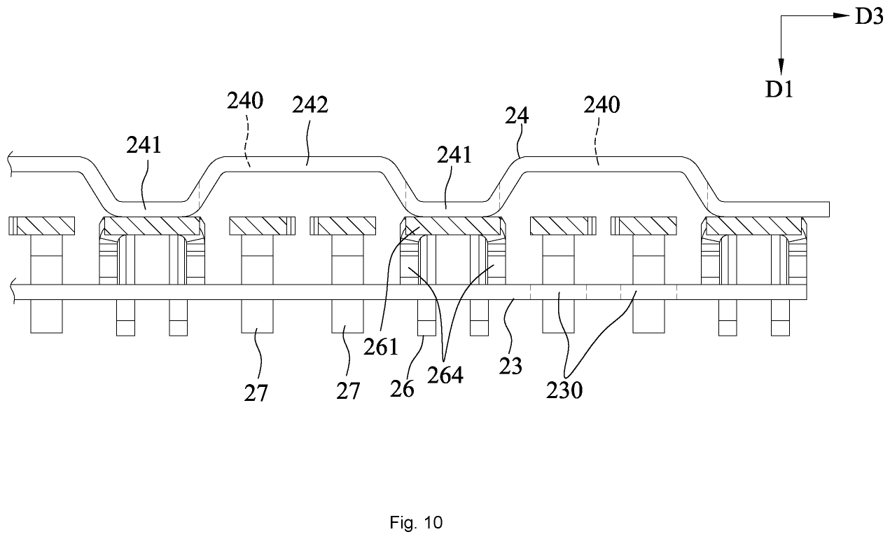

Referring to FIG. 6, FIG. 9 and FIG. 10, the plate-shaped ground shield 23 extends along the third direction D3, and is connected and fixed on front edges of the plate-shaped shielding portions 264 of the plate-shaped ground terminal 26, and has a plurality of first penetrating holes 230 which penetrate along the first direction D1 and respectively correspond to the plate-shaped signal terminals 27.

The wave-shaped ground shield 24 extends along the third direction D3, and is connected and fixed on a rear side of the plate-shaped ground terminal 26. The wave-shaped ground shield 24 has a plurality of connecting portions 241 which are respectively connected on the plurality of plate-shaped ground terminals 26, and a plurality of wave portions 242 which are respectively connected between every two connecting portions 241. The connecting portion 241 is connected and fixed on the second plate-shaped connecting portion 261 of the corresponding plate-shaped ground terminal 26, a part of the two plate-shaped shielding portions 264 and a part of the two plate-shaped tail portions 265. And the wave-shaped ground shield 24 has a plurality of second penetrating holes 240 which penetrate along the first direction D1 and respectively correspond to the plurality of plate-shaped ground terminals 26 in position.

It is noted that, in the present embodiment, the plurality of first penetrating holes 230 and the plurality of second penetrating holes 240 respectively are used to lower entire stress of the plate-shaped ground shield 23 and entire stress of the wave-shaped ground shield 24, but in other implementing manners of the present disclosure, the plate-shaped ground shield 23 is not necessary to have the plurality of first penetrating holes 230, the wave-shaped ground shield 24 is not necessary to have the plurality of second penetrating holes 240.

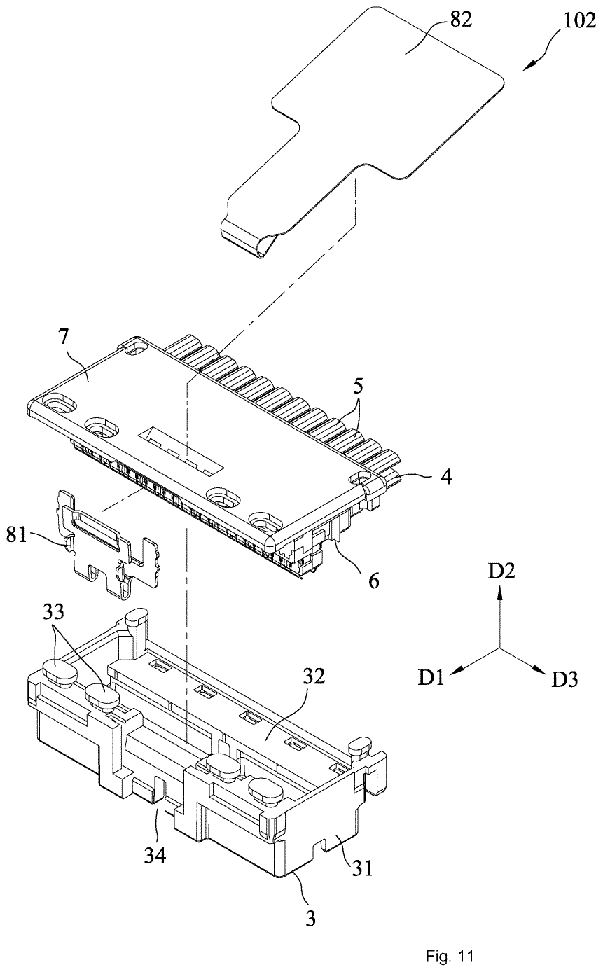

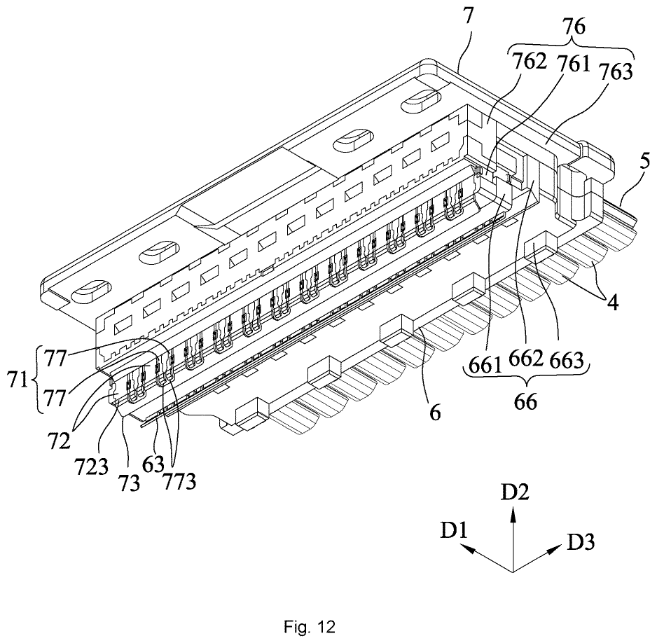

Referring to FIG. 3, FIG. 11 and FIG. 12, the cable-end connector 102 includes an insulative housing 3, a plurality of first cables 4, a plurality of second cables 5, a first terminal wafer 6, a second terminal wafer 7, a locking member 81, and a pulling strap 82. Wherein, the first terminal wafer 6 and the second terminal wafer 7 are provided to the insulative housing 3.

The insulative housing 3 is made by integral formation manner. The insulative housing 3 has a main body portion 31, a supporting portion 32, and a plurality of protruding post 33 which extend upwardly from the main body portion 31. The main body portion 31 is in form of oblong frame shape and is downwardly stacked on the insulative body 12 of the board-end connector 101, and has a retaining groove 34 which is toward the front and allows the locking member 81 to be received therein. The supporting portion 32 extends rearwardly from the main body portion 31 and supports the first terminal wafer 6.

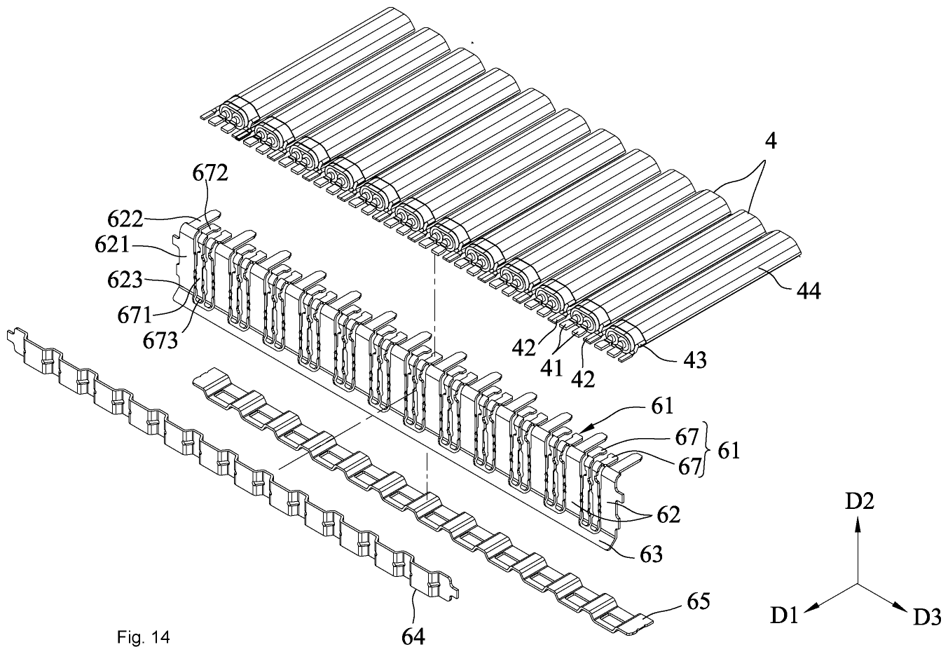

Referring to FIG. 14, the first cable 4 includes two first signal conductors 41 which are spaced apart from each other left and right, and two first ground conductors 42 which are respectively positioned at opposite sides of the two first signal conductors 41. The first cable 4 extends horizontally, and has a first connecting segment 43 and a first extending segment 44 which extends rearwardly from the first connecting segment 43. The two first signal conductors 41 and the two first ground conductors 42 of the first connecting segment 43 are exposed.

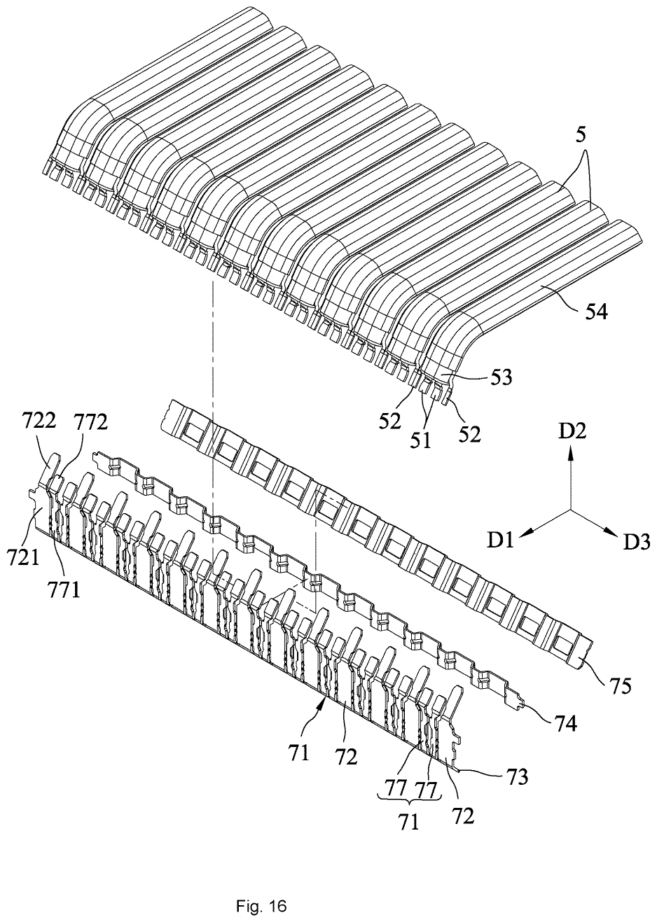

Referring to FIG. 16, the second cable 5 includes two second signal conductors 51 which are spaced apart from each other left and right, and two second ground conductors 52 which are respectively positioned at opposite sides of the two second signal conductors 51. The second cable 5 has a second connecting segment 53 which is oblique, and a second extending segment 54 which horizontally extends rearwardly from the second connecting segment 53. The two second signal conductors 51 and the two second ground conductors 52 of the second connecting segment 53 are exposed.

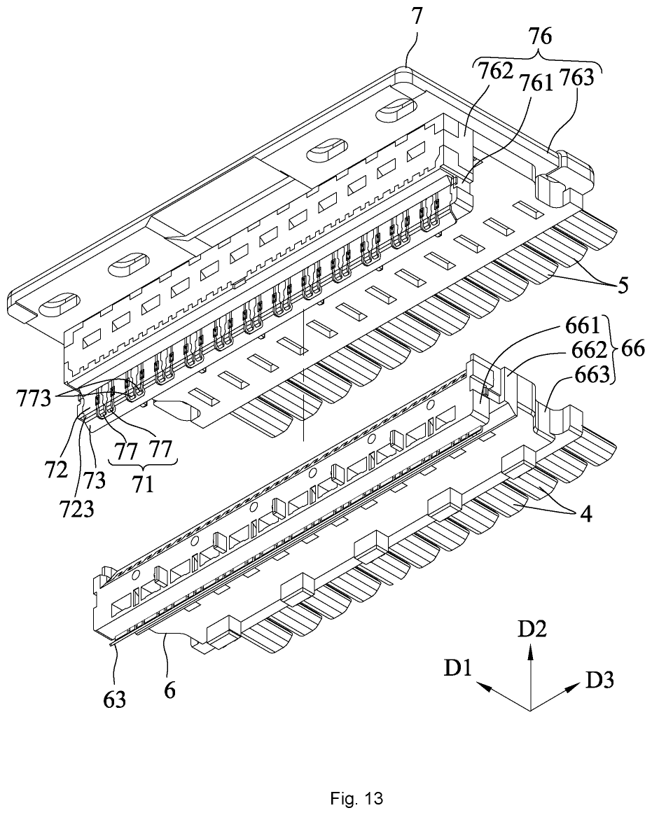

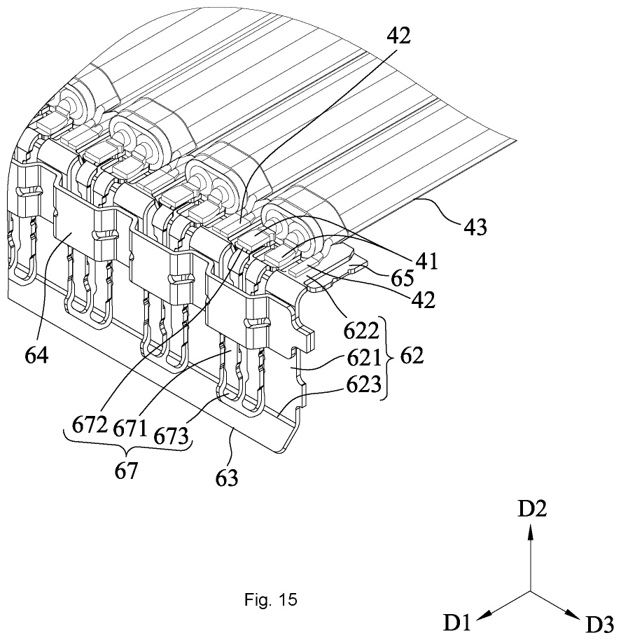

Referring to FIG. 13 to FIG. 15, the first terminal wafer 6 includes a plurality of first signal terminal pairs 61 and a plurality of first ground terminals 62 which are spaced apart from each other and arranged along the third direction D3, a first ground connecting piece 63, a first ground shield 64, a second ground shield 65, and a first cladding assembly 66.

Two sides of the first signal terminal pair 61 each are provided with the first ground terminal 62. Two sides of the first ground terminal 62 each are provided with the first signal terminal pair 61. Specifically, arrangement among the plurality of first ground terminals 62 and the plurality of first signal terminal pairs 61 is sequentially arranged as a sequence of the first ground terminal 62, the first signal terminal pair 61, the first ground terminal 62, the first signal terminal pair 61 along the third direction D3.

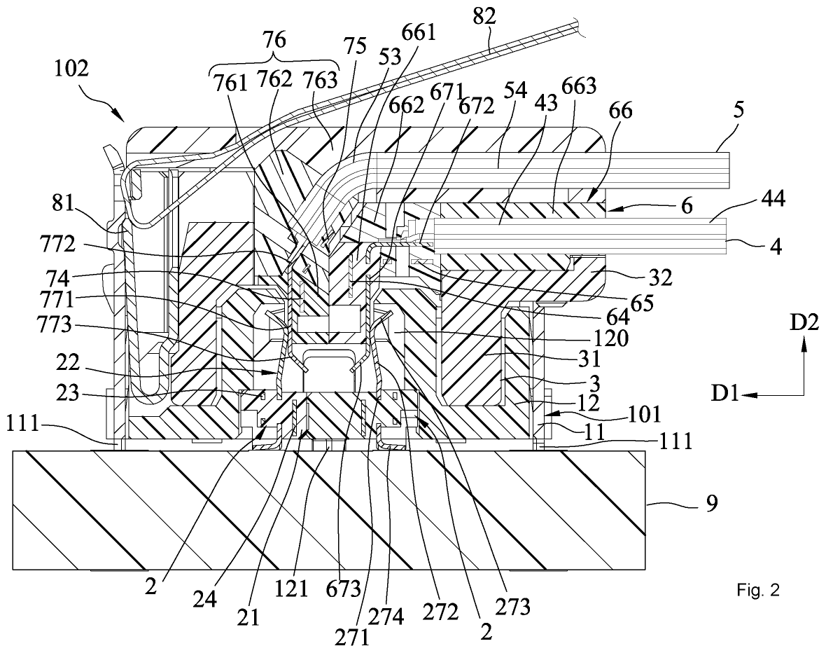

The first signal terminal pair 61 has two first signal terminals 67 which are symmetrical left and right. The first signal terminal 67 has a first body portion 671 which extends along the second direction D2, a first tail portion 672 which extends rearwardly from a top end of the first body portion 671, and a first contact portion 673 which extends downwardly from a tip of the first body portion 671 and bends forwardly as arc. An angle between the first tail portion 672 and the first body portion 671 is 90 degrees (see FIG. 2).

The first ground terminal 62 has a second body portion 621 which extends along the second direction D2, a second tail portion 622 which extends rearwardly from a top end of the second body portion 621, and a second contact portion 623 which extends downwardly from a tip of the second body portion 621 and bends forwardly as arc. An angle between the second tail portion 622 and the second body portion 621 is 90 degrees.

The first ground connecting piece 63 is integrally formed with the plurality of first ground terminals 62 are, and extends along the third direction D3 to be connected to the second contact portions 623.

The first ground shield 64 is connected and fixed on front sides of the second body portions 621 to electrically connect the plurality of first ground terminals 62. It is noted that, in other implementing manners of the present disclosure, the first ground shield 64 also may be connected and fixed on rear sides of the second body portions 621. The second ground shield 65 is connected and fixed on bottom sides of the second tail portions 622 to electrically connect the plurality of first ground terminals 62.

Next, an electrical connection relationship among the plurality of first cables 4, the plurality of first signal terminal pairs 61 and the plurality of first ground terminals 62 is described. The plurality of first cables 4 electrically connect the plurality of first signal terminal pairs 61 respectively. The first connecting segment 43 makes exposed parts of the two first signal conductors 41 respectively connected and fixed on top sides of the first tail portions 672 of the corresponding first signal terminal pair 61 to electrically connect the first signal terminal pair 61. And, the first connecting segment 43 makes exposed parts of the two first ground conductor 42 respectively connected and fixed on top sides of the second tail portions 622 of the two first ground terminal 62 respectively at two sides of the corresponding first signal terminal pair 61 to electrically connect the two first ground terminals 62.

Referring to FIG. 2 and FIG. 13, the first cladding assembly 66 includes a first support member 661, a first cladding member 662 and a second cladding member 663. The first support member 661 clads parts of the first body portions 671, parts of the second body portions 621, and the first ground shield 64. The first cladding member 662 connects the first support member 661, and clads the first tail portions 672, the second tail portions 622, the first connecting segments 43 of the plurality of first cables 4, and the second ground shield 65. The second cladding member 663 connects the first cladding member 662, and clad parts of the first extending segments 44 of the plurality of first cables 4.

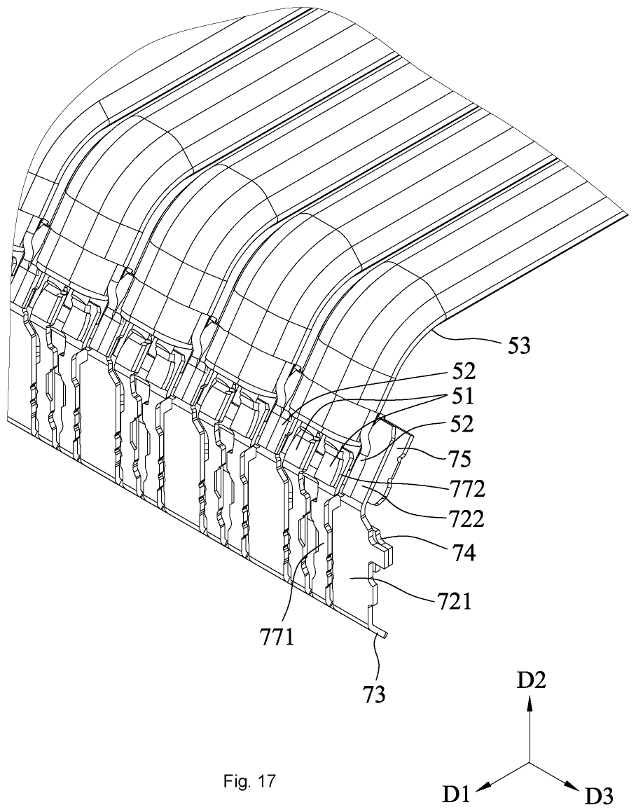

Referring to FIG. 13, FIG. 16 and FIG. 17, the second terminal wafer 7 includes a plurality of second signal terminal pairs 71 and a plurality of second ground terminals 72 which are arranged and spaced apart from each other along the third direction D3, a second ground connecting piece 73, a third ground shield 74, a fourth ground shield 75, and a second cladding assembly 76.

Two sides of the second signal terminal pair 71 each are provided with the second ground terminal 72. Two sides of the second ground terminal 72 each are provided with the second signal terminal pair 71. Specifically, arrangement among the plurality of second ground terminals 72 and the plurality of second signal terminal pairs 71 is sequentially arranged as a sequence of the second ground terminal 72, the second signal terminal pair 71, the second ground terminal 72, the second signal terminal pair 71 along the third direction D3.

The second signal terminal pair 71 has two second signal terminals 77 which are symmetrical left and right. The second signal terminal 77 has a third body portion 771 which extends along the second direction D2, a third tail portion 772 which obliquely extends upwardly and rearwardly from the third body portion 771, and a third contact portion 773 which extends downwardly from the third body portion 771 and bends rearwardly as arc. An angle between The third tail portion 772 and the third body portion 771 is an obtuse angle (see FIG. 2), preferably is about 145 degrees.

The second ground terminal 72 has a fourth body portion 721 which extends along the second direction D2, a fourth tail portion 722 which extends upwardly and rearwardly

from the fourth body portion 721, and a fourth contact portion 723 which extends downwardly from the fourth body portion 721 and bends rearwardly as arc. An angle between the fourth tail portion 722 and the fourth body portion 721 is an obtuse angle, preferably is about 145 degrees.

The second ground connecting piece 73 is integrally formed with the plurality of second ground terminals 72, and extends along the third direction D3 to be connected to the fourth contact portions 723.

The third ground shield 74 is connected and fixed on rear sides of the fourth body portions 721 to electrically connect the plurality of second ground terminals 72. It is noted that, in other implementing manner of the present disclosure, the third ground shield 74 also may be connected and fixed on front sides of the fourth body portions 721. The fourth ground shield 75 are connected and fixed on rear sides of the fourth tail portions 722 to electrically connect the plurality of second ground terminals 72.

Next an electrical connection relationship among the plurality of second cables 5, the plurality of second signal terminal pairs 71 and the plurality of second ground terminals 72 is described. The plurality of second cables 5 electrically connect the plurality of second signal terminal pairs 71 respectively. The second connecting segment 53 makes exposed parts of the two second signal conductors 51 respectively connected and fixed on top sides of the third tail portions 772 of the corresponding second signal terminal pair 71 to electrically connect the second signal terminal pair 71. The second connecting segment 53 makes exposed parts of the two second ground conductor 52 respectively connected and fixed on front sides of the fourth tail portions 722 of the two second ground terminals 72 at two sides of the corresponding second signal terminal pair 71 to electrically connect the two second ground terminals 72.

Referring to FIG. 2 and FIG. 13, the second cladding assembly 76 includes a second support member 761, a third cladding member 762, and a fourth cladding member 763. The second support member 761 clads parts of the third body portions 771, parts of the fourth body portions 721, and the third ground shield 74. The third cladding member 762 connects the second support member 761, and clads the third tail portions 772, the tail portions 722, the second connecting segments 53 of the plurality of second cables 5, and the fourth ground shield 75. The fourth cladding member 763 connects the third cladding member 762, and clads parts of the second extending segments 54 of the plurality of second cables 5. The fourth cladding member 763 is positioned above the main body portion 31 of the insulative housing 3, and takes a plurality of through holes which penetrate up and down and allow the plurality of protruding posts 33 to be assembled therewith and then be engaged and fixed therewith by hot melt, so as to form a cover which covers the insulative housing 3.

It is noted that, the third ground shield 74 and the fourth ground shield 75 are wave-shaped in profile, which is capable of attaining an object that the third ground shield 74 and the fourth ground shield 75 each are connected with the plurality of second ground terminals 72 but each are not connected to the plurality of second signal terminals 77, moreover, the third ground shield 74 and the fourth ground shield 75 each have a plurality of apertures which are capable of lowering entire stress of the third ground shield 74 or the fourth ground shield 75. Because the first ground shield 64 and the third ground shield 74 are the same in profile and the second ground shield 65 and the fourth ground shield 75 are the same in profile, the objects of design structure of the first ground shield 64 and the second ground shield 65 are the same as the reason as described above, so the detailed description thereof is not repeated here.

Referring to FIG. 2 and FIG. 11, the locking member 81 is provided in the retaining groove 34 of the insulative housing 3, and allows the pulling strap 82 to pass therethrough. The pulling strap 82 may allow a user to be operated to detach the cable-end connector 102 from the board-end connector 101. Because the locking member 81 and the pulling strap 82 are not focal point of the present disclosure in structure, so the detailed description thereof is not repeated here.

Referring to FIG. 1 to FIG. 5 and FIG. 13, when the cable-end connector 102 and the board-end connector 101 are mated with each other, the two terminal modules 2 of the board-end connector 101 electrically connect the first terminal wafer 6 and the second terminal wafer 7 of the cable-end connector 102 respectively.

In conclusion, by that the width W4 of the second plate-body portion 262 of the plate-shaped ground terminal 26 is larger than the width W1of the first plate-body portion 272 of the plate-shaped signal terminal 27, it is beneficial to isolate crosstalk between the two adjacent plate-shaped signal terminal pairs 25. In addition, the design that the width of the side segment 2622 of the second plate-body portion 262 gradually increases from up to down is beneficial to optimize stress balance.

The two plate-shaped shielding portions 264 of the plate-shaped ground terminal 26 are used to form shielding between the two adjacent plate-shaped signal terminal pairs 25, and provide good sideward isolation for crosstalk between the two adjacent plate-shaped signal terminal pairs 25. In addition, the larger a distance between the two plate-shaped shielding portion 264 is, the better isolation effect is.

The length L1 and the height H1 of the plate-shaped tail portion 265 of the plate-shaped ground terminal 26 respectively are larger than or equal to the length L2 and the height H2 of the tail end 274 of the plate-shaped signal terminal 27, the plate-shaped tail portion 265 of the plate-shaped ground terminal 26 can transversely shield the tail end 274 of the plate-shaped signal terminal 27, which is beneficial to lower crosstalk problem to promote entire electrical performance of the present disclosure.

The plate-shaped ground shield 23 and the wave-shaped ground shield 24 are cladded by the insulative base 21 and electrically connect the plurality of plate-shaped ground terminals 26, and are respectively positioned at two opposite sides of the plurality of plate-shaped ground terminals 26, increase shielding from crosstalk between the two adjacent plate-shaped signal terminal pairs 25.

In addition, by that the first vertical face portion 2752 of the first plate-body portion 272 and the first vertical face portion 2752 of the other first plate-body portion 272 are parallel to each other, the third vertical face portion 2771 of the first plate-shaped connecting portion 271 and the third vertical face portion 2771 of the other first plate-shaped connecting portion 271 are parallel to each other, and the distance between the second plate-shaped connecting portion 261 and the adjacent first plate-shaped connecting portion 271 is larger than the distance between the second plate-body portion 262 and the adjacent first plate-body portion 272, when the insulative base 21 clads a part of the terminal array 22, it is beneficial to maintain signal integrity (SI) of signals transmitted through the plate-shaped signal terminal pair 25.

Moreover, by the design of the first oblique face portion 2751 and the second oblique face portion 2761 of the plate-shaped signal terminal 27, it ensures that stress distribution is uniform during deflection of the plate-shaped signal terminal 27.

On the other hand, by that the angle between the third tail portion 772 and the third body portion 771 of the second signal terminal 77 is an obtuse angle, and the angle between the fourth tail portion 722 and the fourth body portion 721 of the second ground terminal 72 is an obtuse angle, it makes that the second cable 5 has the second connecting segment 53 which is oblique, it not only lowers a height of the cable-end connector 102, but also reduces stress of the second cable 5 to maximum extent by a gentler bending radius.

In addition, by that the fourth cladding member 763 of the second terminal wafer 7 forms the cover which covers the insulative housing 3, additional assembling and a wall thickness required by an independent cover are eliminated, so that a height of the cable-end connector 102 is further lowered.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

What is claimed is:

1. A cable-end connector, comprising: an insulative housing; a first terminal wafer provided to the insulative housing, and comprising a plurality of first signal terminal pairs, a plurality of first ground terminals, a first ground shield, a second ground shield, and a first cladding assembly, two sides of the first signal terminal pair each being provided with the first ground terminal, and the first signal terminal pair having two first signal terminals, the first signal terminal having a first body portion and a first tail portion and a first contact portion which respectively extend outwardly from two ends of the first body portion, the first ground terminal having a second body portion and a second tail portion and a second contact portion which respectively extend outwardly from two ends of the second body portion, the first ground shield being electrically connected to the second body portions, the second ground shield being electrically connected to the second tail portions; a second terminal wafer provided to the insulative housing, and comprising a plurality of second signal terminal pairs, a plurality of second ground terminals, a third ground shield, a fourth ground shield, and a second cladding assembly, two sides of the second signal terminal pair each being provided with the second ground terminal, and the second signal terminal pair having two second signal terminals, the second signal terminal having a third body portion and a third tail portion and a third contact portion which respectively extend outwardly from two ends of the third body portion, the second ground terminal having a fourth body portion and a fourth tail portion and a fourth contact portion which respectively extend outwardly from two ends of the fourth body portion, the third ground shield being electrically connected to the fourth body portions, the fourth ground shield being electrically connected to the fourth tail portions; a plurality of first cables electrically connected to the first tail portions and the second tail portions; and a plurality of second cables electrically connected to the third tail portions and the fourth tail portions.

2. The cable-end connector of claim 1, wherein angles between the first body portion and the first tail portion and between the second body portion and the second tail portion are each 90 degrees, the first cables respectively correspond to the first signal terminal pairs, the first cable has a first connecting segment which extends horizontally, and the first connecting segment is electrically connected to the first tail portions of the corresponding first signal terminal pair and the second tail portions of the two first ground terminals which are positioned at the two sides of the corresponding first signal terminal pair.

3. The cable-end connector of claim 1, wherein the first cladding assembly comprises: a first support member at least partially cladding the first body portions, the second body portions, and the first ground shield; a first cladding member cladding the first tail portions, the second tail portions, the first connecting segments of the plurality of first cables, and the second ground shield; and a second cladding member cladding a part of the first cladding member and parts of first extending segments of the plurality of first cables.

4. The cable-end connector of claim 1, wherein the second ground shield is electrically connected to bottom sides of the second tail portions, and the first ground shield is electrically connected to front sides of the second body portions.

5. The cable-end connector of claim 1, wherein angles between the third body portion and the third tail portion and between the fourth body portion and the fourth tail portion are each an obtuse angle, the second cables respectively correspond to the second signal terminal pairs, the second cable has second connecting segments which extends obliquely, and the second connecting segments are electrically connected to the third tail portions of the corresponding second signal terminal pair and the fourth tail portions of the two second ground terminals which are positioned at the two sides of the corresponding second signal terminal pair.

6. The cable-end connector of claim 5, wherein the second cladding assembly comprises: a second support member at least partially cladding the third body portions, the fourth body portions, and the third ground shield; a third cladding member cladding the third tail portions, the fourth tail portions, the second connecting segments, and the fourth ground shield; and a fourth cladding member cladding a part of the third cladding member and parts of second extending segments and covering and fixed on the insulative housing.

7. The cable-end connector of claim 1, wherein the fourth ground shield is electrically connected to rear sides of the fourth tail portions, and the third ground shield is electrically connected to rear sides of the fourth body portions.

8. The cable-end connector of claim 1, wherein the first terminal wafer further comprises a first ground connecting piece which is connected to the second contact portions, and the second terminal wafer further comprises a second ground connecting piece which is connected to the fourth contact portions.

9. The cable-end connector of claim 5, wherein the obtuse angles between the third tail portion and the third body portion and between the fourth tail portion and the fourth body portion are each about 145 degrees.

10. The cable-end connector of claim 1, wherein the fourth ground shield is electrically connected to rear sides of the fourth tail portions, and the third ground shield is electrically connected to rear sides of the fourth body portions.

11. A board-end connector, comprising: a metal shell; an insulative body provided in the metal shell; and two terminal modules received in the insulative body, each terminal module comprising an insulative base which is provided to the insulative body, a terminal array, a plate-shaped ground shield, and a wave-shaped ground shield, the terminal array having a plurality of plate-shaped signal terminal pairs and a plurality of plate-shaped ground terminals, each plate-shaped ground terminal being positioned adjacent to a plate-shaped signal terminal pair of the plurality of plate-shaped signal terminal pairs with the plate-shaped ground terminal, and the plate-shaped signal terminal pair having two plate-shaped signal terminals which are spaced apart from each other, the plate-shaped signal terminal having a first plate-shaped connecting portion which is at least partially cladded by the insulative base, a first plate-body portion and a tail end which respectively extend outwardly from two ends of the first plate-shaped connecting portion, and an elastic contact end which extends outwardly from the first plate-body portion, a width of the first plate-body portion being larger than a width of the elastic contact end, the two first plate-body portions of the plate-shaped signal terminal pair being therebetween spaced apart from each other by a preset distance, the plate-shaped ground terminal having a second plate-shaped connecting portion which is at least partially cladded by the insulative base, a second plate-body portion which extends outwardly from the second plate-shaped connecting portion, a plate-shaped elastic contact end which extends outwardly from the second plate-body portion, two plate-shaped shielding portions which respectively extend from two sides of the second plate-shaped connecting portion along an extending direction of the tail end, and two plate-shaped tail portions which respectively downwardly extend from tips of the two plate-shaped shielding portions, a width of the second plate-body portion being larger than a width of the plate-shaped elastic contact end and being larger than the width of the first plate-body portion, a length of the plate-shaped tail portion which extends in the same direction as the extending direction of the tail end being larger than or equal to the tail end, the plate-shaped ground shield and the wave-shaped ground shield being cladded by the insulative base and being electrically connected to the plate-shaped ground terminals, and being respectively positioned at two opposite sides of the plate-shaped ground terminals.

12. The board-end connector of claim 11, wherein the insulative base further clads parts of the plate-shaped tail portions.

13. The board-end connector of claim 11, wherein the first plate-body portion has a first face which faces the other first plate-body portion, and a second face which is opposite to the first face, the first face having a first oblique face portion which extends obliquely from the elastic contact end down and toward the other first plate-body portion, and a first vertical face portion which connects the first oblique face portion and the first plate-shaped connecting portion, the first vertical face portion being parallel to a first vertical face portion of the other first plate-body portion, the second face having a second oblique face portion which extends obliquely from the first plate-shaped connecting portion up and toward the other first plate-body portion, and a second vertical face portion which extends from the second oblique face portion upwards and connects to the elastic contact end, the first plate-shaped connecting portion having a third face which faces the other first plate-shaped connecting portion and has a third vertical face portion, the third vertical face portion being parallel to a third vertical face portion of the other first plate-shaped connecting portion, the second plate-body portion having an opening in form of inverted cone and comprising two side segments which define two sides of the opening, a width of the side segment gradually increasing from up to down, a distance between the second plate-shaped connecting portion of the plate-shaped ground terminal and the first plate-shaped connecting portion of the adjacent plate-shaped signal terminal being larger than a distance between the second plate-body portion of the plate-shaped ground terminal and the first plate-body portion of the adjacent plate-shaped signal terminal, the distance between the second plate-shaped connecting portion of the plate-shaped ground terminal and the first plate-shaped connecting portion of the adjacent plate-shaped signal terminal being larger than a distance between the first plate-shaped connecting portions of the plate-shaped signal terminal pair.

14. The board-end connector of claim 11, wherein a height of the plate-shaped tail portion along a second direction perpendicular to an extending direction of the tail end is larger than or equal to a height of the tail end along the second direction.

15. The board-end connector of claim 11, wherein the plate-shaped ground shield is connected and fixed on front edges of the plate-shaped shielding portions of the plate-shaped ground terminals, and the wave-shaped ground shield is connected and fixed on rear sides of the second plate-shaped connecting portions of the plate-shaped ground terminals.

16. An electrical connection device, comprising: a cable-end connector, comprising: an insulative housing; a first terminal wafer provided to the insulative housing, and comprising a plurality of first signal terminal pairs, a plurality of first ground terminals, a first ground shield, a second ground shield, and a first cladding assembly, two sides of the first signal terminal pair each being provided with the first ground terminal, and the first signal terminal pair having two first signal terminals, the first signal terminal having a first body portion, a first tail portion and a first contact portion which respectively extend outwardly from two ends of the first body portion, the first ground terminal having a second body portion, a second tail portion and a second contact portion which respectively extend outwardly from two ends of the second body portion, the first ground shield being electrically connected to the second body portions, the second ground shield being electrically connected to the second tail portions; a second terminal wafer provided to the insulative housing, and comprising a plurality of second signal terminal pairs, a plurality of second ground terminals, a third ground shield, a fourth ground shield, and a second cladding assembly, two sides of the second signal terminal pair each being provided with the second ground terminal, and the second signal terminal pair having two second signal terminals, the second signal terminal having a third body portion, a third tail portion and a third contact portion which respectively extend outwardly from two ends of the third body portion, the second ground terminal having a fourth body portion, a fourth tail portion and a fourth contact portion which respectively extend outwardly from two ends of the fourth body portion, the third ground shield being electrically connected to the fourth body portions, the fourth ground shield being electrically connected to the fourth tail portions; a plurality of first cables electrically connected to the first tail portions and the second tail portions; and a plurality of second cables electrically connected to the third tail portions and the fourth tail portions; a board-end connector, comprising: a metal shell; an insulative body provided in the metal shell; and two terminal modules received in the insulative body and electrically connecting the first terminal wafer and the second terminal wafer of the cable-end connector respectively, the terminal module comprising an insulative base which is provided to the insulative body, a terminal array, a plate-shaped ground shield, and a wave-shaped ground shield, the terminal array having a plurality of plate-shaped signal terminal pairs and a plurality of plate-shaped ground terminals, two sides of the plate-shaped signal terminal pair each being provided with the plate-shaped ground terminal, and the plate-shaped signal terminal pair having two plate-shaped signal terminals which are spaced apart from each other, the plate-shaped signal terminal having a first plate-shaped connecting portion which is at least partially cladded by the insulative base, a first plate-body portion and a tail end which respectively extend outwardly from two ends of the first plate-shaped connecting portion, and an elastic contact end which extends outwardly from the first plate-body portion, a width of the first plate-body portion being larger than a width of the elastic contact end, the two first plate-body portions of the plate-shaped signal terminal pair being therebetween spaced apart from each other by a preset distance, the plate-shaped ground terminal having a second plate-shaped connecting portion which is at least partially cladded by the insulative base, a second plate-body portion which extends outwardly from the second plate-shaped connecting portion, a plate-shaped elastic contact end which extends outwardly from the second plate-body portion, two plate-shaped shielding portions which respectively extend from two sides of the second plate-shaped connecting portion along an extending direction of the tail end, and two plate-shaped tail portions which respectively downwardly extend from tips of the two plate-shaped shielding portions, a width of the second plate-body portion being larger than a width of the plate-shaped elastic contact end and being larger than a width of the first plate-body portion, a length of the plate-shaped tail portion which extends in the same direction as the extending direction of the tail end being larger than or equal to the tail end, the plate-shaped ground shield and the wave-shaped ground shield being cladded by the insulative base and being electrically connected to the plate-shaped ground terminals, and being respectively positioned at two opposite sides of the plate-shaped ground terminals.

17. The electrical connection device of claim 16, wherein angles between the first body portion and the first tail portion and between the second body portion and the second tail portion are each 90 degrees, the first cables respectively corresponding to the first signal terminal pairs with each first cable having a first connecting segment extending horizontally and electrically connected to the first tail portions of the corresponding first signal terminal pair and the second tail portions of the two first ground terminals positioned at the two sides of the corresponding first signal terminal pair; and wherein angles between the third body portion and the third tail portion and between the fourth body portion and the fourth tail portion are each an obtuse angle, the second cables respectively corresponding to the second signal terminal pairs with each second cable having a second connecting segment extending obliquely and electrically connected to the third tail portions of the corresponding second signal terminal pair and the fourth tail portions of the two second ground terminals positioned at the two sides of the corresponding second signal terminal pair.

18. The electrical connection device of claim 16, wherein the first cladding assembly comprises: a first support member at least partially cladding the first body portions, the second body portions, and the first ground shield; a first cladding member cladding the first tail portions, the second tail portions, the first connecting segments of the plurality of first cables, and the second ground shield; and a second cladding member cladding a part of the first cladding member and parts of first extending segments of the plurality of first cables; and wherein the second cladding assembly comprises: a second support member at least partially cladding the third body portions, the fourth body portions, and the third ground shield; a third cladding member cladding the third tail portions, the fourth tail portions, the second connecting segments of the plurality of second cables, and the fourth ground shield; and a fourth cladding member cladding a part of the third cladding member and parts of second extending segments of the plurality of second cables and covering and fixed on the insulative housing.

19. The electrical connection device of claim 16, wherein the second ground shield is electrically connected to bottom sides of the second tail portions, the first ground shield is electrically connected to front sides of the second body portions; the fourth ground shield is electrically connected to rear sides of the fourth tail portions, the third ground shield is electrically connected to rear sides of the fourth body portions; the first terminal wafer further comprises a first ground connecting piece which is connected to the second contact portions; and the second terminal wafer further comprises a second ground connecting piece which is connected to the fourth contact portions.

20. The electrical connection device of claim 16, wherein the insulative base further clads parts of the plate-shaped tail portions.
